(19) United States
(12) Patent Application Publication
(10) Pub. No.: US 2006/0172095 A1
(43) Pub. Date: Aug. 3, 2006

(54) Gas-filled bubble sheets for application in civil engineering

(76) Inventor: Manfred Elsaesser, Patsch (AT)

Correspondence Address: ROTHWELL, FIGG, ERNST & MANBECK, P.C., 1425 K STREET, N.W., SUITE 800, WASHINGTON, DC, 20005, US

(21) Appl. No.: 10/531,729

(22) PCT Filed: Jun. 10, 2002
(86) PCT No.: PCT/EP02/06296

§ 371 Date: Dec. 23, 2005

(30) Foreign Application Priority Data
Jun. 15, 2001 (DE) 201 09 885.7

(51) Int. Cl. B32B 27/10

(52) U.S. Cl. 428/34.2

(57) ABSTRACT

A gas-filled bubble sheet for application in civil engineering is formed from several films of coextruded layers, in which barrier materials are located. By varying the barrier materials and the sequence of layers, the bubble sheet can also be made suitable for conditions encountered in construction, in particular with regard to the gas impermeability, the load-bearing properties, the dynamic stiffness and damping properties thereof.

### CROSS REFERENCE TO RELATED APPLICATION

This application is a 35 U.S.C. §371 National Phase Entry Application from PCT/EP02/06296, filed Jun. 10, 2002, and designating the U.S.

### BACKGROUND OF THE INVENTION

1. Field of the Invention

The invention relates to a gas-filled bubble sheet for application in civil engineering and a use of a gas-filled bubble sheet comprising barrier materials for footfall sound insulation in civil engineering.

2. Description of the Background Art

The use of air bubble films or bubble sheets is generally known for cushioning and packaging purposes. These materials do not have to meet high requirements regarding load-bearing capacity, in particular in the case of local action at a point, and life. The films used for production accordingly generally consist of materials of low diffusion density—such as, for example, low density (LD) polyethylene.

On the other hand, bubble sheets have had only limited applications to date in the construction sector.

Regarding the damping or insulation of acoustic quantities, it is known from construction physics that, in the construction sector, sufficient footfall sound insulation of dividing components in combination with realistic component masses can be achieved only by multi-shell—as a rule double-shell—components or by the combination of heavy single-shell partition ceilings with soft and springy floor coverings. Double-shell partition ceilings are generally in the form of floating floor screeds and as a rule require relatively large construction heights which can scarcely be realized in practice with most existing connection heights, particularly in the renovation of old buildings. When calculating the minimum footfall sound improvement factor FSI_{req} of multilayer floor coverings which is required for the minimum footfall protection of the entire structure, not all European countries permit soft and springy floor coverings to be included. Moreover, they are unsuitable or unacceptable for use in some cases, in particular in wet areas (bathrooms).

On the other hand, relatively thin, rigid floor coverings and wall claddings have increasingly been used recently, for example those consisting of chipboards or pressboards in floorboard sizes with extremely hard surfaces, for example including those comprising plastic laminates. The behaviour of these floor or wall coverings—which have a single-shell effect—is critical and subjectively unpleasant, particularly with regard to the footfall sound radiation into the room where walking occurs.

In Germany and Austria, floating floor screeds are standard versions with regard to footfall sound insulation. However, owing to their ageing and the possibility of replaceability, floor coverings are not permitted to be included for the sound test for the minimum footfall sound insulation. The resonant frequency of soft and springy floor coverings decreases with increasing contact time; this in turn depends on the depth of penetration of the exciting object into the covering layer, and this in turn is of course dependent on the dimensions and the mass of the footfall sound generator. This relationship is also the reason why results from the measurement of the sound level reductions by floor coverings by means of the standard hammer unit differ fundamentally from those obtained when walking on the same partition ceiling structure.

In building practice, thin rigid floor coverings are also laid as floating structures if they ensure a sufficient load distribution, and could therefore in principle constitute an intermediate solution between a floating floor screed and a soft and springy floor covering. At present, however; the disadvantages of such floor coverings with regard to the footfall sound insulation generally consist in the fact that
on the one hand, the mass of the load-distributing layer is generally relatively small, and the dynamic stiffness of the intermediate layer therefore has to be substantially less than 10 MN/m³ for achieving an acceptable footfall sound improvement factor of the double-shell structure, which is achievable with conventional footfall sound insulation materials only in combination with fairly large layer thicknesses, which in turn result in large construction heights;
on the other hand, the footfall sound behaviour of the rigid single-shell floor covering itself is extremely unsatisfactory—even in subjective terms—owing to the additionally very generally hard surface layer, the associated small depth of penetration of the footfall sound generator (short contact times) and the resulting unfavourable resonant frequency. This often also becomes noticeable through unpleasant walking noises (rattle) in the room where walking takes place.

Air bubble films, for example of polyethylene, having cylindrical air bubbles for heat insulation of building components are disclosed in the patent JP 110043803.

Air bubble films for footfall sound insulation under floating floor screeds are disclosed, for example, in DE 2 841 208 or CH 645968; however, these proposals do not offer an adequate solution with regard to room acoustics or air-borne sound insulation. In addition, air bubble films of the prior art for applications in the construction sector have only unsatisfactory resistance to localized loads and a limited service life owing to the loss of the gas filling.

Air cushion films having an improved load-bearing capacity and a process for the production thereof are disclosed in the Patent Application DE 4114 506.

For application in the building sector—in contrast to conventional air bubble films, for example those which have become known from the packaging industry or for use in the area of shoe inlay soles from U.S. Pat. No. 5,584,130 or U.S. Pat. No. 6,127,026, and the materials of said air bubble films—the gas- or air-filled bubbles of such sound insulation layers are tailored to one another in their dimension, their height and their spacing in the deliberate manner so that the combination of the rigidity of the skeleton of the plastic film used, the dynamic stiffness of the gas (air) enclosed in the bubbles and finally also of the air present in the installed state between the bubbles results in a dynamic stiffness of less than 20, preferably <10 MN/m³. This can already be achieved either by means of a single-layer bubble film or by the combination of two or more bubble films.

### SUMMARY OF THE INVENTION

In contrast to polyethylene air bubble films already known per se from the packaging industry, the bubble sheets which can be used in the construction industry, in particular in building construction, must have some further specific properties with regard to the sound insulation, heat insulation and moisture protection.

In addition to the dynamic stiffness parameter s′, the stability of footfall sound insulation bubble films does of course also play a decisive role when said bubble films are used in practice in the construction sector. For this purpose, the thickness of the plastic films used should of course accordingly be chosen so that the degree of filling of the bubbles remains sufficiently constant over the relevant period and the load-bearing capacity of the bubble film in the installed state remains sufficiently large and stable.

The heat insulation of thin footfall sound insulation bubble films which is to be achieved can be improved by lamination with top layers if their surface facing the bubbles has a low relative emission coefficient εᵣ (as far as possible less than 0.1). By means of this, it is in fact possible to minimize the fraction of total heat transfer due to heat radiation via the air layer present between the bubbles, the remainder of said heat transfer generally also being caused by convection and heat conduction.

It is the object of the invention to provide a bubble sheet which can also be used in the construction sector and there in particular for floor coverings and which meets the particular requirements with regard to service life and load-bearing capacity.

A further object is to provide a bubble sheet which, for example as a component of a sound insulation system, ensures both footfall sound insulation and reduced radiation.

These objects are achieved, according to the invention, by the characterizing features of Claim 1. Advantageous and alternative embodiments and further developments are evident from the features of the subclaims.

The invention is based on the concept that bubble films/sheets comprising barrier materials, preferably based on mechanically thermoformed coextruded blown films can be used, with a specific choice and (possibly symmetrical) arrangement of the individual layers, not only as in the past predominantly in the packaging industry but are also to be used in a number of technical applications in which exclusively smooth film webs are still used at present.

However, a precondition for this is that, compared with the above-described prior art for air bubble films, the novel bubble sheet actually
has a substantially improved mechanical short-term load-bearing capacity (tightness of the bubbles—preferably filled with an inert gas—even at high pressures), but also long-term stability (low permeability value especially for the gas content), and can nevertheless be welded tight and hence
results in heat insulation, sound insulation and moisture protection characteristics which also opens up combined use in building construction and civil engineering and simultaneously small construction heights.

A suitable process for the production of a bubble sheet according to the invention is disclosed in the Patent Applications AT 14/A 1034/89, DE 4114 596 and EP 0779 137. There, air cushion films and processes for their production are described, which, owing to the use of film webs of high density polyethylene (HDPE of 0.94-0.96 g/cm³), polypropylene, polyamide or polyester of high density and having a thickness of less than 15 μm, in particular of monofilms or coextruded blown films having the same strength and elongation in the longitudinal and transverse direction, have two and a half times and up to four times higher mechanical strength than these air cushion films of lower tightness which are known from the packaging industry.

Each film web may be formed from a multiplicity of coextruded layers, for example up to nine coextruded layers, so that, depending on the composition of the layers, the air cushion film can be adapted to a variety of intended uses. Thus, for example, coloured, UV-stabilized, antistatic, diffusion-inhibiting or in particular tightly sealed layers can be used. In order to achieve good tightness of the air cushion films, it has proved to be particularly advantageous if the barrier material is an ethylene/vinyl alcohol copolymer (EVOH) since, in this case, the permeability for gaseous substances and therefore the danger of diffusion are reduced by about 90%.

Further films of extruded microlayers comprising barrier materials are disclosed in the Application WO 00/76765.

The requirements described above can be fulfilled, for example, by bubble films produced in the “offline process” (air bubble films known to date are all thermoformed “inline” under vacuum) and have the following layer structure:
1. a mechanically thermoformed 7-layer coextruded blown film as bottom film with a total thickness of at least 28 μm, consisting of
   polypropylene or polyethylene−adhesion promoter−polyamide−9 μm ethylene/vinyl alcohol copolymer or 9 μm polyvinylidene chloride−polyamide−adhesion promoter−polypropylene
   in short form with conventional abbreviations
   PP (or PE)+HV+PA+9 μm EVOH+PA+HV+PE,
   or
   PP (or PE)+HV+PA+9 μm PVDC+PA+HV+PE,
2. a “top film web” for stabilizing the thermoformed bubbles, comprising
   12 μm polyethylene terephthalate (PET) metallized (optical density OD 2.5 to 3.1)+polyurethane (PU) adhesive+14 μm 2-layer coextruded blown film,
   these having in each case a thin covering of a low density polyethylene having a relatively low melting point, or a copolymer of low density, for better bonding, and
3. an inert gas filling comprising noble gases which have as large atoms as possible and a thermal conductivity of less than 0.12 W/mK, such as, for example, argon or krypton, for which the permeability of the film materials is not more than 3 cm³/m²·atm·24 h (i.e. per day).

Preferably, high density polyethylene (HDPE) and either linear low density polyethylene (LLDPE) or very low density polyethylene (VDPE) can be used for the 2-layer coextruded blown film of the top film web. Both in the bottom film and in the top film web, further barrier materials can be introduced for reducing the permeability.

Instead of the polypropylene top layer of the air bubbles, once again a polyethylene film web (as on the underneath of the blown film) can be used for easier thermal adhesion (lamination) of the bubble sheet. The metallization of the polyethylene terephthalate layer of the “top film web” is indispensable on the one hand with regard to the reduction of the permeability of this layer to a value equivalent to that possessed by the bubbles themselves in combination with the barrier material. On the other hand, this metal layer reflecting heat radiation—at least in combination with the top layers still selectively permeable to infrared radiation

can likewise advantageously influence the heat insulation of the bubble sheet. However, the metal layer reduces the deformability and hence the processing possibilities of the top layer.

As an alternative, two metallized films can also be joined at their metal surfaces.

The gas-filled bubbles therefore have a short-term load-bearing capacity of up to 100 kN m² (10⁵ Pa) and a dynamic stiffness of less than or equal to 20 MN/m³ and a uniaxial expansion loss factor of tan δ>0.1, preferably of tan δ>0.2. In combination with noble gas fillings having low coefficients of thermal conductivity of <0.12 W/mK (argon, krypton, etc.), equivalent coefficients of thermal conductivity of ≦0.025 W/mK can be achieved for the bubble sheet.

With these parameters, the bubble sheet described above is suitable in particular for use in combination with floorboards (genuine wood parquet, veneer and laminate boards) and in combination with electrical panel heating sandwiches and/or sound insulation systems provided on the underside of the boards.

In composite sound insulation systems—in contrast to the sound insulation measures known from the prior art and in the form of an additional individual layer—the two influencing parameters known per se and critical for the radiation behaviour of acoustically nonabsorbing floor coverings, internal sound insulation and footfall sound improvement, are made optimizable for the individual application by the functional distribution over a plurality of separate individual layers.

By the combination of a thin, relatively light load distribution plate with a sound damping layer and with an air bubble film as a specially dimensioned insulation layer, the advantages of double-shell constructions can also be achieved for floor structures having relatively small area dimensions of the individual layers. For example, even a thin, sufficiently rigid floor covering itself can perform the load distribution function.

In such a composite sound insulation system, the bubble sheet according to the invention in combination with the further components has an acoustic effect, i.e. apart from any heat insulation and vapour diffusion properties, in three respects, namely
a. primarily as an acoustic measure in the room for improving the radiation behaviour of thin, rigid and acoustically nonabsorbing floor coverings in the accessed room itself for avoiding a subjectively extremely unpleasant rattle in the upper frequency range relevant for construction acoustics, which rattle is typical of such floor coverings,
b. as a footfall sound-reducing measure for achieving an acceptable footfall sound improvement factor even with acoustically nonabsorbing floor coverings (as a variant to the soft and springy floor coverings generally used for this purpose in practice),
c. additionally as a measure effective for airborne sound insulation.

Applications for the bubble sheet according to the invention are in particular
1. in building construction, both as a footfall sound insulation film and as a load-bearing heat insulation layer in combination with an electrical panel floor heating system under floorboards
2. in civil engineering, as a “friction-reducing” inlay under, for example, solid concrete floor slabs, and additionally as weldable sealing sheet in tunnel construction.

### BRIEF DESCRIPTION OF THE DRAWINGS

The bubble sheet according to the invention is described in more detail below purely by way of example with reference to embodiments shown schematically in the drawing. Specifically,

FIG. 1 shows schematic diagrams for layers of two film webs for the production of a bubble sheet according to the invention;

FIG. 2 shows a schematic diagram of the combination of two film webs for producing an individual bubble of a bubble sheet according to the invention, in side view, and

FIG. 3 shows a schematic diagram of the layers of an individual bubble of a bubble sheet according to the invention, in side view.

### BRIEF DESCRIPTION OF THE PREFERRED EMBODIMENTS

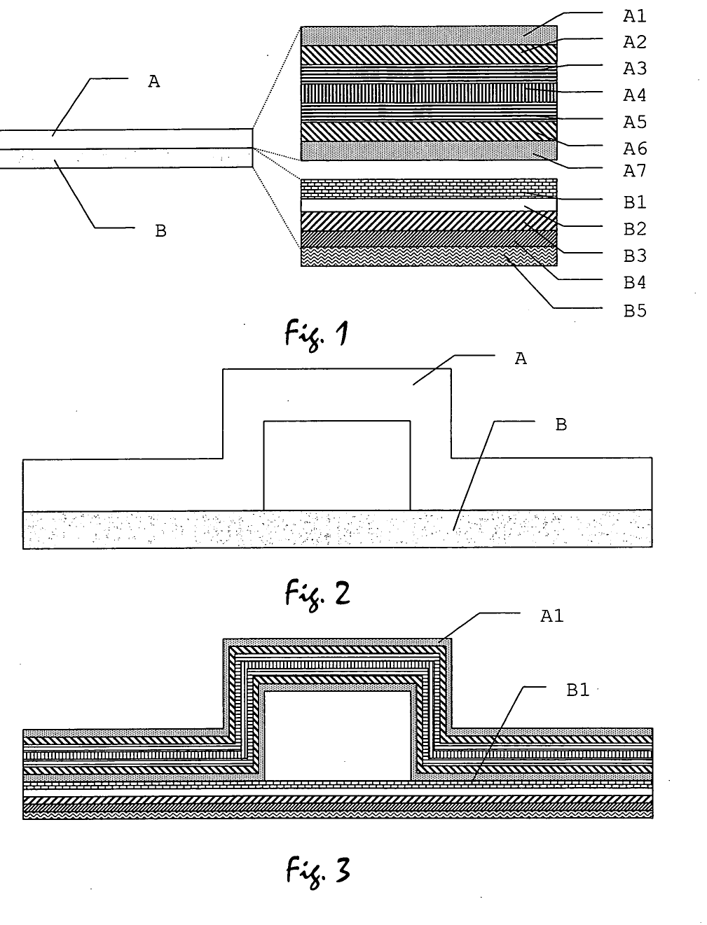

FIG. 1 shows, purely by way of example, the structure of a film for the production of a bubble sheet according to the invention. The film consists of a first film web A and a second film web as top film web B. The first film web A is composed symmetrically of the 7 layers comprising polyethylene A1, adhesion promoter A2, polyamide A3, ethylene/vinyl alcohol copolymer A4, polyamide A5, adhesion promoter A6 and polyethylene A7. Alternatively, the layers A1 and/or A7 may also consist of polypropylene, or the layer A4 may consist of polyvinylidene chloride.

The top film web B consists of a layer of polyethylene terephthalate B1, a metallization layer B2, a layer of polyurethane adhesive B3 and layers of coextruded blown film B4 and B5. The layer B4 may be produced, for example, from high density polyethylene for achieving the required strength of the total film web, and the layer B5 may be produced from linear low density polyethylene or very low density polyethylene for achieving good or easier weldability.

FIG. 2 shows the combination of a thermoformable first film web A shaped into a bubble, and a top film web B. The two film webs are bonded to one another and form gas-tight bubbles C, which can be filled with an inert gas, e.g. argon, during the production.

FIG. 3 schematically shows the sequence of the layers in the region of a bubble which is formed by a thermoformable first film web A and a final top film web B. To illustrate the orientation of the layers, the polyethylene layer is designated Al and the polyethylene terephthalate layer B1.

The drawings are designed purely schematically for representing and illustrating a layer structure of the film webs according to the invention. In particular, no information about actual relationships can be derived from the dimensions and ratios shown.

1. Gas-filled bubble sheet for application in civil engineering, comprising at least two film webs which are connected to one another and contain at least one barrier material, and of which at least one comprises a plurality of preferably biaxially oriented layers, characterized in that a first, thermoformable film web has at least 5 layers as a bottom web,
the barrier material, preferably ethylene/vinyl alcohol copolymer (EVOH), polyvinylidene chloride (PVDC) or polyethylene terephthalate (PET),
being embedded between two layers of adhesion-improving and/or load-distributing material, such as, for example, polyamide (PA) and/or an adhesion promoter,
and the outer layers of the film web consisting of a weldable material, preferably polypropylene (PP) or polyethylene (PE).

2. Bubble sheet according to claim 1, characterized in that at least one of the layers, preferably that comprising polyethylene terephthalate (PET) or polypropylene (PP), carries a metal coating.

3. Bubble sheet according to claim 1, characterized in that the layer of barrier material has a thickness of at least 4 μm, preferably about 9-20 μm.

4. Bubble sheet according to claim 1, characterized in that the adhesion-improving and/or load-distributing layers have a thickness of, in each case, at least 2 μm, preferably about 10 μm

5. Bubble sheet according to claim 1, characterized in that the outer layers of weldable material, together with the respective adhesion promoter layer, have a thickness of, in each case, at least 10 μm, preferably about 15-30 μm.

6. Bubble sheet according to claim 1, characterized in that a second film web as a top film web has layers in the following sequence:
Polyethylene terephthalate (PET) or polypropylene (PP),
metallization,
polyurethane adhesive,
an at least 2-layer, preferably 5-7-layer, coextruded film, in particular containing one layer each of high density polyethylene (HDPE) and either linear low density polyethylene (HDPE) and either linear low density polyethylene (LLDPE) or very low density polyethylene (VDPE).

7. Bubble sheet according to claim 1, characterized in that at least one film web contains a further barrier material.

8. Bubble sheet according to claim 1, characterized in that the first film web has a total thickness of 28-120 μm, preferably about 40-80 μm, and, in the second film web, the metallized PET layer or PP layer has a thickness of 10-20 μm, preferably about 12 μm, and the 2-7 layers of coextruded film have a total thickness of 10-50 μm, preferably about 20-40 μm.

9. Bubble sheet according to claim 6, characterized in that the metallized PET layer or PP layer in the second film web has an optical density of 2.5 to 3.1.

10. Bubble sheet according to claim 1, characterized in that the bubbles are filled with an inert gas, preferably argon, or with an inert gas mixture.

11. Use of a gas-filled bubble sheet comprising a plurality of film webs, of which at least one film web comprises a plurality of layers and at least one of these layers contains a barrier material, for footfall sound insulation and/or as a heat-insulating layer in civil engineering.
